(19) United States
(12) Patent Application Publication
(10) Pub. No.: US 2026/0351695 A1
(43) Pub. Date: Nov. 5, 2026

(54) ELECTRIC ENERGY STORAGE DEVICE AND BATTERY-POWERED ELECTRIC DEVICE

(71) Applicant: Viridis Energy GmbH, Stuttgart (DE)

(72) Inventors: Timotheus JAHNKE, Stuttgart (DE); Philipp EILMANN, Remseck am Neckar (DE)

(21) Appl. No.: 19/712,753

(22) Filed: Jun. 18, 2026

Related U.S. Application Data
(63) Continuation of application No. PCT/EP2024/087495, filed on Dec. 19, 2024.

(30) Foreign Application Priority Data
Dec. 22, 2023 (DE) 10 2023 136 625.4

(51) Int. Cl. H01M 10/42; H01M 10/44; H01M 50/247; H02J 7/82

(52) U.S. Cl. CPC H01M 10/425; H01M 10/44; H01M 50/247; H02J 7/82; H01M 2220/30

(57) ABSTRACT

The invention relates to an electrical energy storage device comprising a housing, at least one rechargeable battery cell accommodated in the housing, and a control and/or regulation unit for controlling and/or regulating charging and discharging of the at least one rechargeable battery cell and for monitoring a state of charge thereof, wherein the electrical energy storage device comprises an electrical deep-discharge device for irreversibly deep-discharging the at least one battery cell, and wherein the electrical deep-discharge device is configured independently of the control and/or regulation unit and can be actuated or activated independently thereof.

Furthermore, an improved battery-electrically operated electrical appliance is proposed

The present invention relates to an electrical energy storage device comprising a housing, at least one rechargeable battery cell accommodated in the housing, and a control and/or regulation unit for controlling and/or regulating the charging and discharging of the at least one rechargeable battery cell and for monitoring a state of charge thereof.

Furthermore, the present invention relates to a battery-electrically operated electrical appliance having at least one electrical load and an electrical energy storage device for supplying the electrical load with electrical energy.

Electrical appliances and energy storage devices of the type described above are known in a wide variety of forms. As battery cells, lithium-ion cells, also referred to as lithium-ion batteries, are very frequently used, which are capable of providing high currents in combination with high gravimetric and volumetric energy density. Energy storage devices having lithium-ion cells are excellently suited as mobile energy storage devices and also as stationary energy storage devices. Their use is not only limited to the field of electric vehicles, in particular battery-electric motor vehicles, but they are also used in electric hand tools, garden tools, computers, and mobile telephones.

With the increasing spread of lithium-ion cells, the actual risk of malfunctions thereof is also increasing. This applies in particular to discarded energy storage devices whose battery cells have reached the end of their life cycle, i.e., which satisfy the so-called end-of-life (EOL) condition. In particular, they can no longer be charged sufficiently for continued use.

However, such battery cells still contain a certain amount of electrical energy due to the chemical properties of lithium-ion cells. Therefore, lithium-ion cells must not be discharged below a specific threshold voltage in order to preserve reversible charging and discharging. As a result, as already mentioned, a certain residual amount of energy inevitably remains stored in the respective battery cell. This may lead to critical failures when energy storage devices having lithium-ion cells are disposed of. In particular, in the event of a short circuit of a lithium-ion cell, the remaining residual energy is often still sufficient to cause local overheating, self-ignition, and thereby a fire or even an explosion.

US 2022/0019273 A1 describes a method for deactivating a battery on the basis of a user command.

It is therefore an object of the present invention to improve an electrical energy storage device and a battery-electrically operated electrical appliance such that, in particular, the electrical energy storage device can be disposed of safely.

According to the invention, this object is achieved in an electrical energy storage device of the type described above in that it comprises an electrical deep-discharge device for irreversibly deep-discharging the at least one battery cell and in that the electrical deep-discharge device is configured independently of the control and/or regulation unit and can be actuated or activated independently thereof.

Further developing an electrical energy storage device in the proposed manner has the particular advantage that it can be brought into a defined state in which the at least one rechargeable battery cell accommodated in the housing is deep-discharged, such that no electrical energy remains stored therein, or only such a small amount of energy remains stored therein that the risk of self-ignition or explosion is substantially eliminated. The deep discharge can be carried out in a particularly simple manner by means of the electrical deep-discharge device. Since it is configured independently of the control and/or regulation unit, which is also referred to as a Battery Management System (BMS), and can also be actuated or activated independently thereof, deep discharge is possible reliably and independently of an operating state of the control and/or regulation unit. A BMS requires a minimum voltage in order to remain functional. Therefore, due to system-related limitations, it is not possible in the event of a fault to discharge the at least one battery cell under BMS control. By contrast, the deep-discharge device enables, in particular, the deep discharge of battery cells installed in the energy storage device, as required for the safe disposal of the energy storage device. These may, for example, be lithium-ion cells or rechargeable nickel-cadmium, alkaline, or nickel-metal hydride batteries. They comprise an anode and a cathode separated from one another by an electrically insulating separator element. Ions are exchanged between the two electrodes within the battery cell, for example lithium ions in the case of a lithium-ion cell. Electrons, by contrast, are conducted via an external electrical circuit.

The lithium-ion cell, for example, stores electrical energy in the form of an electrochemical potential between the anode and the cathode. Both electrodes consist of active materials that interact with lithium ions, namely by enabling the intercalation of lithium ions into a host lattice. Charging increases the voltage difference between the two electrodes. Conversely, discharging reduces the voltage difference. Due to the chemical properties of lithium-ion cells, in particular the chemical composition and crystal structure of the active cathode material, lithium-ion cells must not be discharged to 0 V, i.e., deep-discharged, if they are intended to be recharged. Reversible charging and discharging are only possible if a specific threshold voltage, or minimum potential, between the anode and cathode is not undershot. Lithium-ion cells are therefore typically operated within a voltage range between 2.5 V and approximately 4.2 V to 4.4 V. The irreversible destruction effect of the battery cell is caused by an unstable crystal structure of the active cathode material, which undergoes an irreversible phase transition during deep discharge. As explained, the minimum voltage of the lithium-ion battery is approximately 2.5 V if it is to be operated reversibly. For reversible use, that is, when the electrical energy storage device comprising at least one rechargeable battery cell is intended to be charged and discharged, the state of charge (SOC) of a lithium-ion cell that is considered to be discharged, i.e., is at the cutoff voltage of 2.5 V, is still approximately 5% to approximately 30% of the maximum storable energy. Thus, even in a lithium-ion cell that is discharged in accordance with its intended use for subsequent recharging, a significant amount of residual energy remains. As explained, the battery management system (BMS) prevents deep discharge. It therefore controls the lower discharge voltage to 2.5 V per battery cell. However, this gives rise to a problem, namely that residual energy remains in each battery cell, which can lead to critical failures during the disposal of such lithium-ion cells, particularly when they are installed in electrical energy storage devices. In the event of a short circuit, the energy remaining at the lower discharge voltage is still sufficient to cause substantial localized heating, self-ignition, or even explosions. By means of the electrical deep-discharge device, it is possible in particular for the at least one battery cell at the end of its life cycle, or at the end of the life cycle (EOL) of the electrical energy storage device—or independently thereof at any time upon initiation by a user—to be completely discharged. The proposed electrical energy storage device therefore enables, in particular, an end user to deliberately and in a defined manner deep-discharge the at least one rechargeable battery cell before disposing of the electrical energy storage device, such that the energy storage device can be disposed of safely, i.e., without electrical energy remaining in the at least one battery cell. The functionality of the deep-discharge device is ensured in particular by the fact that, as explained above, it is configured independently of the control and/or regulation unit and can be actuated or activated independently thereof. Deep discharge is therefore possible reliably even if the BMS is no longer operational due to insufficient residual energy remaining in the at least one battery cell.

It is advantageous if the deep-discharge device comprises at least one deep-discharge circuit, which electrically conductively connects a first terminal and a second terminal of the at least one battery cell, and if the deep-discharge circuit comprises at least one electrical deep-discharge switching element which, in an operating position in which the at least one deep-discharge circuit is interrupted, is open and can be irreversibly transferred from the open operating position into a closed deep-discharge position in which the at least one deep-discharge circuit is closed. Configuring the deep-discharge device in this manner has the particular advantage that irreversible deep discharge can be carried out by activating the deep-discharge device. This is ensured in particular by the fact that, by means of the deep-discharge device, the deep-discharge circuit can be irreversibly transferred from the open operating position into the closed deep-discharge position. In the deep-discharge position, the residual energy remaining stored in the at least one battery cell can be withdrawn by electrically conductively connecting the two terminals of the at least one battery cell to one another via the deep-discharge circuit.

Preferably, the at least one deep-discharge switching element is configured to be actuated exclusively mechanically. In this manner, the energy storage device can be configured such that the deep-discharge device cannot be actuated electrically or electronically by the control and/or regulation unit. Mechanical actuation of the at least one deep-discharge switching element, and thus also of the deep-discharge device, makes it possible in particular to perform deep discharge only when it is actually desired. For example, it can be activated by a user in a desired manner before disposal of the energy storage device.

The deep-discharge device can be configured in a simple manner if the deep-discharge switching element is designed in the form of a self-latching pushbutton that remains in the deep-discharge position, a switch, or a plug connection. A plug connection has the particular advantage that, for example, by moving a plug element from a first position into a second position, switching contacts can be brought into electrical operative connection with one another in order thereby to close the at least one deep-discharge circuit.

Advantageously, the deep-discharge switching element is configured such that it can no longer be transferred from the closed position back into the open position. It is therefore preferably configured such that it can be transferred irreversibly from the open position into the closed position.

Preferably, the deep-discharge switching element is designed as an electrically passive component. Such an embodiment has the particular advantage that a switching operation can be carried out reliably and that no electrical energy is required for the switching operation.

It is advantageous if the deep-discharge switching element comprises a first contact element electrically operatively connected to the first terminal and a second contact element electrically operatively connected to the second terminal, which are separated from one another in the operating position and are in electrically conductive operative connection with one another in the deep-discharge position. By bringing the first and second contact elements into contact with one another, the at least one deep-discharge circuit can be closed such that the electrical energy stored in the at least one battery cell can be deliberately discharged therefrom via the at least one deep-discharge circuit and, for example, converted into heat in a defined manner.

According to a preferred embodiment, provision may be made for the deep-discharge device to comprise at least one, in particular only a single, mechanically actuable actuating element, which can be moved from an unactuated initial position, in which the deep-discharge switching element assumes the operating position, into a deep-discharge position by the application of an actuating force, in which the deep-discharge switching element assumes the closed deep-discharge position. Such an embodiment has the particular advantage that the at least one battery cell cannot be unintentionally deep-discharged by control from the control and/or regulation unit. Rather, the at least one mechanically actuable actuating element must be actuated deliberately and consciously by a user in order to activate the deep-discharge device for deep-discharging the at least one battery cell.

A compact design of the energy storage device can be achieved in particular in that the deep-discharge switching element comprises the actuating element. For example, the actuating element may be implemented by a mechanical rocker switch of an electrical switch which, as a result of movement, brings two contact elements of the switch into electrically conductive operative connection with one another.

Reliable actuation of the deep-discharge device is possible in particular if the actuating element can be moved on the housing from the operating position into the deep-discharge position in the direction of, or away from, a housing interior defined by the housing.

For example, the actuating element may be designed on the housing in the form of a button that can be pressed by a user and thereby moved toward the housing interior.

It is advantageous if the actuating element is arranged or configured on the housing so as to be displaceable and/or pivotable or rotatable. This enables a user, in particular, to activate the deep-discharge device by displacing and/or pivoting and/or rotating the actuating element on and thus relative to the housing and to transfer the at least one electrical deep-discharge switching element from the open operating position into the closed deep-discharge position.

It is advantageous if the actuating element is arranged or configured such that, in order to transfer the deep-discharge switching element from the operating position into the deep-discharge position, it can be displaced and/or rotated and/or pivoted relative to the housing.

This embodiment also enables a user to recognize, from the position or orientation of the actuating element relative to the housing, whether the deep-discharge device has already been activated or not. This is particularly advantageous for determining whether an electrical energy storage device intended for disposal, or already disposed of, has been deliberately deep-discharged or not. In this manner, the actuating element may simultaneously form an indicating element that indicates whether the at least one deep-discharge switching element is in the open operating position or in the closed deep-discharge position.

It is advantageous if the actuating element comprises an actuating pin which is in mechanical and electrical operative connection with the electrical deep-discharge switching element in such a way that the electrical deep-discharge switching element can be transferred from the operating position to the deep-discharge position. Thus, in particular, the actuating pin is designed to mechanically and electrically transfer the electrical deep-discharge switching element from the operating position to the deep-discharge position. In the operating position, the electrical deep-discharge switching element assumes a default position in which it is open.

It is advantageous if the actuating element is operatively connected to the first contact element for moving the first contact element from the operating position to the deep-discharge position. In this manner, the at least one deep-discharge switching element can, in particular, be transferred directly from the operating position to the deep-discharge position by actuation of the actuating element. In doing so, it can, in particular, mechanically transmit an actuating force to the first contact element.

It is advantageous if the actuating element is formed integrally with the first contact element, in particular as a monolithic component, or is connected to the first contact element by a force-fit and/or form-fit and/or material-bonded connection. In this way, especially movement of the actuating element can reliably move the first contact element in the desired manner in order to close the at least one deep-discharge circuit.

A particularly compact design of the electrical energy storage device can be achieved, in particular, if the actuating element comprises or forms the first contact element.

For reliable deep discharge, it is particularly advantageous if the actuating element is in electrically operative connection with the first and second contact elements in the deep-discharge position and is in electrically operative connection with neither or only one of the two contact elements in the operating position. For example, the actuating element may be designed in the form of an actuating pin which is displaced in order to establish an electrical operative connection with the two contact elements. This may be implemented, for example, such that the two electrical contact elements are ring-shaped and the actuating element can be inserted into the ring-shaped contact elements in such a manner that it electrically conductively connects both contact elements, thereby enabling current to flow from the first contact element through the actuating element, or through an electrically conductive portion thereof, to the second contact element, or vice versa.

In order to enable defined activation of the deep-discharge device, it is advantageous if the actuating element comprises an actuation-tool element for force-fitting and/or form-fitting engagement with an actuation tool for moving the actuating element. The actuation-tool element may in particular be designed in the form of a recess or a projection. For example, it may be designed as a recess in order to engage with a screwdriver or a coin. The shape of the recess or projection may in particular be configured as a slot, a cross recess, an internal multi-lobbed profile, an external multi-lobbed profile, an internal polygon, or an external polygon.

In order to prevent unintentional actuation of the actuating element, it is advantageous if the actuating element is arranged or configured on the housing so as to be recessed inwardly relative to an outer housing surface in the direction of a housing interior defined by the housing. In particular, this ensures that the deep-discharge device cannot be activated unintentionally by actuation of the actuating element, for example if the electrical energy storage device falls out of a user's hand. Since the actuating element is arranged or configured in a recessed manner on the housing as defined above, it does not protrude beyond the outer housing surface and therefore cannot be actuated automatically when the energy storage device falls.

Reliable arrangement of the actuating element is possible in particular if it is arranged or configured in or in the region of a housing recess formed or arranged relative to the outer housing surface. By virtue of this configuration, the actuating element is substantially protected by surrounding by the housing recess.

In order to enable defined access to the actuating element, it is advantageous if the housing recess is open in a direction facing away from the housing interior.

According to a further preferred embodiment, provision may be made for the electrical deep-discharge device to comprise two or more deep-discharge circuits, for each deep-discharge circuit to comprise an actuating element, and for one actuating element to be assigned to each deep-discharge circuit. This embodiment makes it possible in particular to deep-discharge each battery cell of the electrical energy storage device independently of one another.

Furthermore, it may be advantageous if the deep-discharge device comprises two or more deep-discharge circuits and only a single actuating element which is in mechanical operative connection with all deep-discharge switching elements of the deep-discharge device for transferring all deep-discharge switching elements, in particular simultaneously or successively, from the operating position into the deep-discharge position. This embodiment has the particular advantage that only a single actuating element must be actuated in order to discharge all battery cells comprised by the electrical energy storage device. Deep discharge may then take place simultaneously or successively. In any event, this embodiment ensures in particular that all battery cells can be deep-discharged by actuating the single actuating element.

In order to prevent unintentional actuation of the actuating element, it is advantageous if the actuating element is concealed, covered, and/or protected by a protective element in the operating position. In order to deep-discharge such an electrical energy storage device in the intended manner, the protective element must be removed or destroyed. Otherwise, the actuating element is inaccessible to the user.

It is advantageous if the protective element closes the housing recess in the operating position. Access to the actuating element can therefore be obtained only when the protective element sufficiently, in particular completely, exposes the housing recess. For this purpose, the protective element must be destroyed or removed wholly or partially.

Preferably, the protective element is designed in the form of a cover. Such a cover reliably protects the housing recess and thus an accommodation space for the actuating element, in particular in the operating position.

It is advantageous if the protective element and the housing are connected to one another in a protective position by force-fitting, form-fitting, and/or material-bonding engagement.

This embodiment makes it possible in particular for the protective element to reliably protect the actuating element, especially against unintentional actuation.

Preferably, the protective element and the housing are configured to be separable from one another irreversibly. This enables a user to recognize immediately whether the protective element has already been removed or not. It may therefore also serve as a type of indicating element informing a user that the deep-discharge device may already have been actuated or not.

The electrical energy storage device can be configured simply and cost-effectively if the protective element is designed in the form of a protective film adhesively attached to the housing.

In order to reliably protect the actuating element, it is advantageous if the protective element is connected to or engaged with the housing in a protective position via a bayonet connection or threaded connection. This embodiment enables the protective element to be moved by rotation or screwing action in order to transfer it from the protective position into a position in which it is, for example, separated from the housing or completely or partially exposes the actuating element.

In order to prevent unintentional actuation of the deep-discharge device, it is advantageous if the protective element is arranged in the protective position such that the mechanically actuable actuating element is concealed and access thereto is impossible.

Furthermore, it may be advantageous if the protective element comprises a tool-coupling element for engagement with a correspondingly configured tool element of a tool. Such an embodiment makes it possible in particular to prevent unintentional actuation of the protective element. In this embodiment, removal of the protective element requires a special tool element configured to correspond to the tool-coupling element.

The tool-coupling element may be configured in a simple manner in the form of a slot. Alternatively, it may also be designed in the form of a cross-shaped recess, an internal polygon, or an internal multi-lobbed profile.

According to a further preferred embodiment, provision may be made for the at least one deep-discharge circuit to comprise at least one electrical deep-discharge resistor which converts the electrical energy stored in the at least one battery cell into heat in the deep-discharge position. By means of the electrical deep-discharge resistor, which forms an electrical load, the electrical energy still contained in the at least one battery cell can thus be converted into heat in a defined manner. The electrical deep-discharge resistor is selected in particular such that the electrical energy can be converted into heat sufficiently slowly so that overheating, ignition, or explosion cannot occur. The electrical deep-discharge resistor therefore forms, in particular, an electrical load capable of converting electrical energy into heat. In principle, other electrical loads comprised by the electrical energy storage device may also be provided. In particular, electrical deep-discharge resistors that are already comprised by the electrical energy storage device for other purposes may also be used.

In particular, such a deep-discharge resistor may form a passive component of a control and/or regulation unit. In this case, the deep-discharge device nevertheless remains activatable and actuable independently of the control and/or regulation unit, since the electrical deep-discharge resistor merely constitutes a passive component of the control and/or regulation unit and is used solely for converting electrical energy into heat.

Preferably, the at least one deep-discharge resistor has a resistance value in a range from approximately 2 ohms to approximately 20 kΩ. By specifying the resistance value of the deep-discharge resistor, a discharge time can also be predetermined. In particular, this may be selected such that reliable heat dissipation is possible in order to prevent overheating of the deep-discharge device and of the electrical energy storage device, as well as unwanted ignition or explosion thereof.

Furthermore, it may be advantageous for the electrical energy storage device to comprise at least one heat-conducting element and for the at least one deep-discharge circuit to be thermally conductively connected to the at least one heat-conducting element in order to dissipate heat generated in the at least one deep-discharge circuit during deep discharge, in particular out of the housing. The heat-conducting element may in particular be arranged on the housing. It may be designed in the form of a heat sink or comprise such a heat sink, which is thermally conductively connected to the at least one deep-discharge resistor in order to dissipate heat therefrom and thus from the deep-discharge circuit.

It is advantageous if the at least one heat-conducting element comprises at least one heat sink which is thermally conductively connected to the at least one deep-discharge circuit, in particular to the at least one electrical deep-discharge resistor. In this manner, heat generated during deep discharge can be reliably dissipated, in particular out of the housing of the electrical energy storage device.

In order to be able to supply a battery-electrically operated device reliably with energy and to enable the highest possible energy density, it is advantageous if the at least one battery cell is designed in the form of a lithium-ion battery. Such a battery is also referred to as a lithium-ion cell.

Furthermore, it may be advantageous for the electrical energy storage device to comprise two or more rechargeable battery cells and for the deep-discharge device to comprise a single deep-discharge circuit for all battery cells, one deep-discharge circuit for two or more battery cells, or a separate deep-discharge circuit for each battery cell. The described embodiment makes it possible, in particular, to store correspondingly larger amounts of electrical energy and provide such energy for operation of a battery-electrically operable electrical appliance by providing two or more battery cells. Configuring the deep-discharge device as described additionally makes it possible to deep-discharge all battery cells of the electrical energy storage device in a defined and reliable manner.

The object stated at the outset is further achieved according to the invention in a battery-electrically operated electrical appliance of the type described above in that the electrical energy storage device is designed in the form of one of the advantageous embodiments of electrical energy storage devices described above.

The battery-electrically operated electrical appliance therefore likewise exhibits the advantages described above in connection with advantageous embodiments of electrical energy storage devices.

Battery-electrically operated electrical appliances may be configured in various forms.

In particular, they may advantageously be designed in the form of cleaning devices, power tools, electrically driven vehicles, in particular motor vehicles, or garden tools. This list is, of course, not limiting.

It is advantageous if the at least one electrical load is designed in the form of a heating device and/or in the form of an electric motor. Such a battery-electrically operated electrical appliance may in particular be used as a cleaning device, power tool, or garden tool. By means of an electric motor, for example, cutting devices of garden tools or vehicles, in particular motor vehicles, can be driven. By means of a heating device, fluids such as water or other cleaning agents can in particular be heated.

It is advantageous if the electrical energy storage device is configured to be detachably connectable to the battery-electrically operated electrical appliance such that, in an operating position, it is in electrical operative connection with the electrical appliance and, in a storage position, is disengaged from the electrical appliance. This makes it possible, in particular, to remove the electrical energy storage device from the electrical appliance when the at least one battery cell has been discharged. The electrical appliance can then be connected to another electrical energy storage device that is charged and can continue to be operated.

In this manner, continuous operation of the electrical appliance can be achieved.

The object stated at the outset is further achieved according to the invention in a method of the type described above in that the at least one battery cell is irreversibly deep-discharged independently of the control and/or regulation unit.

As explained in detail above, deliberate deep discharge of the at least one battery cell independently of the control and/or regulation unit makes it possible, in particular, to ensure that no electrical energy remains in the at least one battery cell of an electrical energy storage device intended for disposal that is sufficient to ignite the electrical energy storage device or cause it to explode.

It is advantageous if, for deep-discharging the at least one rechargeable battery cell, a first terminal and a second terminal of the battery cell are transferred from an operating position, in which they are electrically conductively disengaged from one another, into a deep-discharge position, in which they are electrically conductively connected directly or indirectly via at least one electrical load, such that the electrical energy stored in the at least one battery cell is converted into heat in the deep-discharge position, in particular by means of the at least one electrical load. In the manner described, the electrical energy stored in the rechargeable battery cell can be deliberately converted into heat in a defined manner. The at least one electrical load may in particular be comprised by a deep-discharge circuit, for example in the form of an electrical resistor.

Furthermore, the use of one of the advantageous embodiments of electrical energy storage devices described above for carrying out one of the advantageous methods described above is proposed.

The following description of preferred embodiments of the invention serves, in conjunction with the drawings, to provide a more detailed explanation. In the drawings:

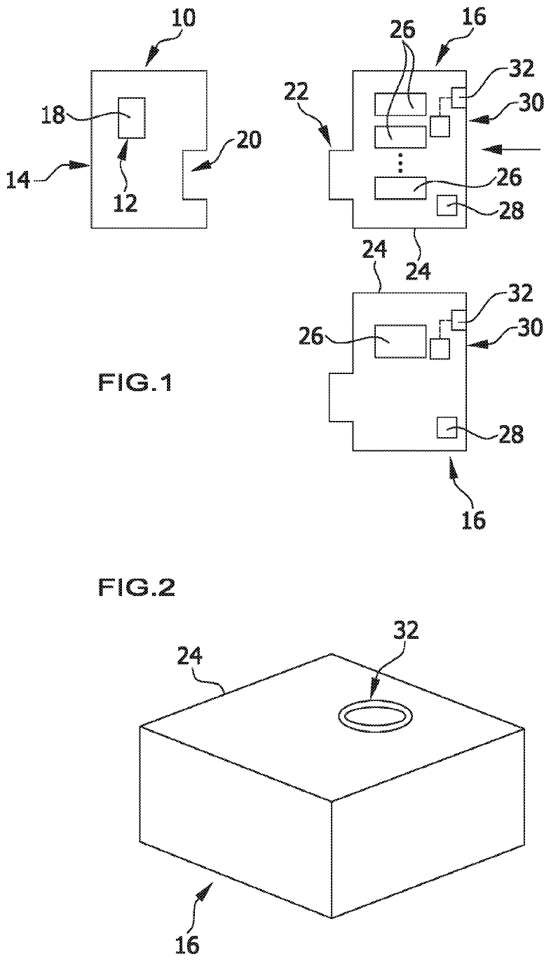

FIG. 1 shows a schematic illustration of an embodiment of a battery-electrically operated electrical appliance with two embodiments of electrical energy storage devices;

FIG. 2 shows a schematic perspective view of an embodiment of an electrical energy storage device;

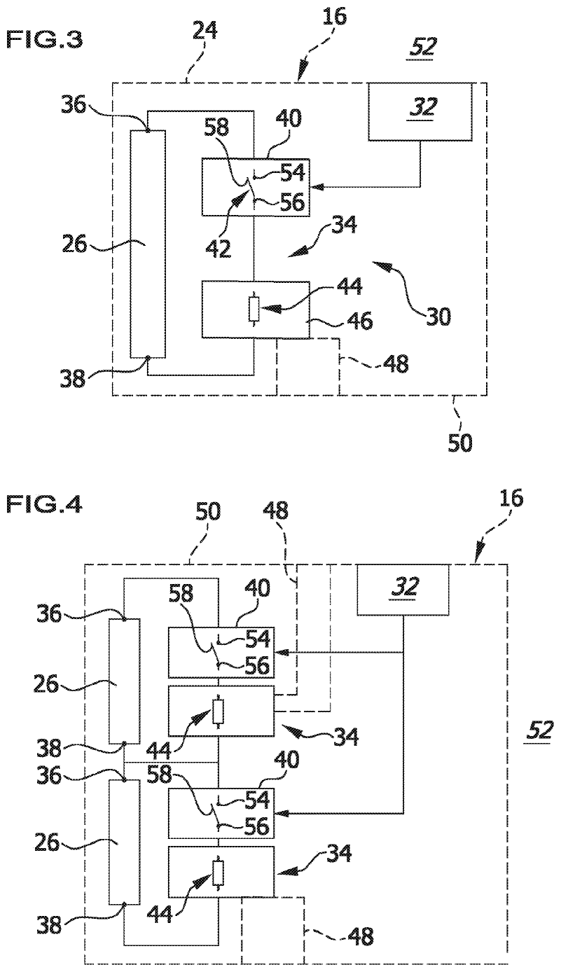

FIG. 3 shows a schematic illustration of the structure of an embodiment of an electrical energy storage device;

FIG. 4 shows a schematic illustration of the structure of a further embodiment of an electrical energy storage device;

FIG. 5 shows a schematic perspective partial view of a further embodiment of an electrical energy storage device;

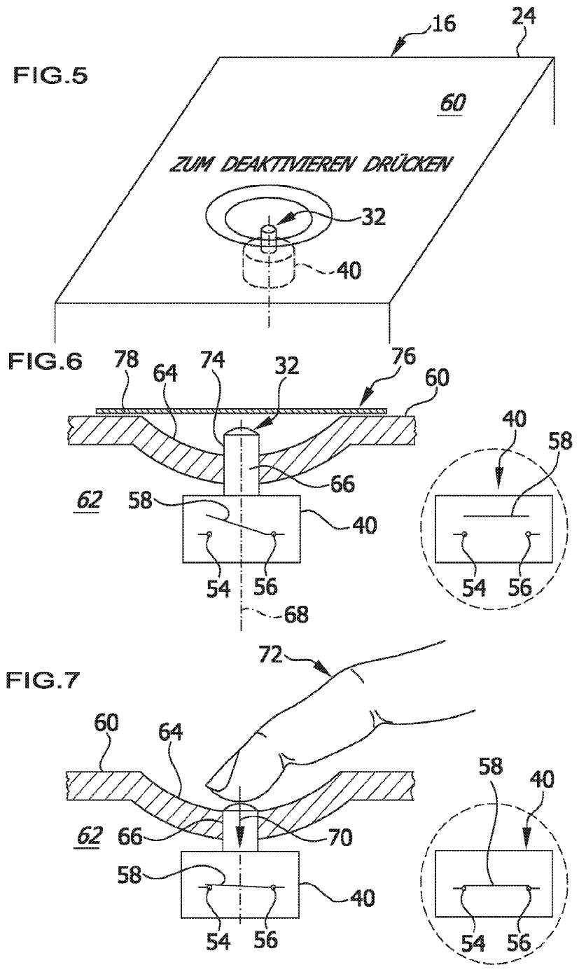

FIG. 6 shows a schematic partial sectional view of the arrangement according to FIG. 5;

FIG. 7 shows a view similar to FIG. 6 during actuation of an actuating element;

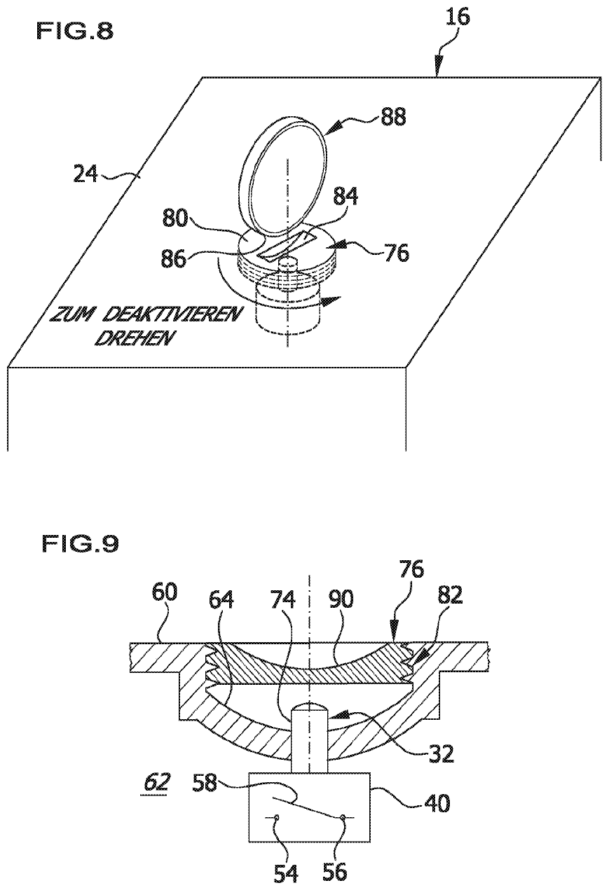

FIG. 8 shows a schematic perspective partial view of a further embodiment of an electrical energy storage device;

FIG. 9 shows a schematic partial sectional view of the arrangement according to FIG. 8;

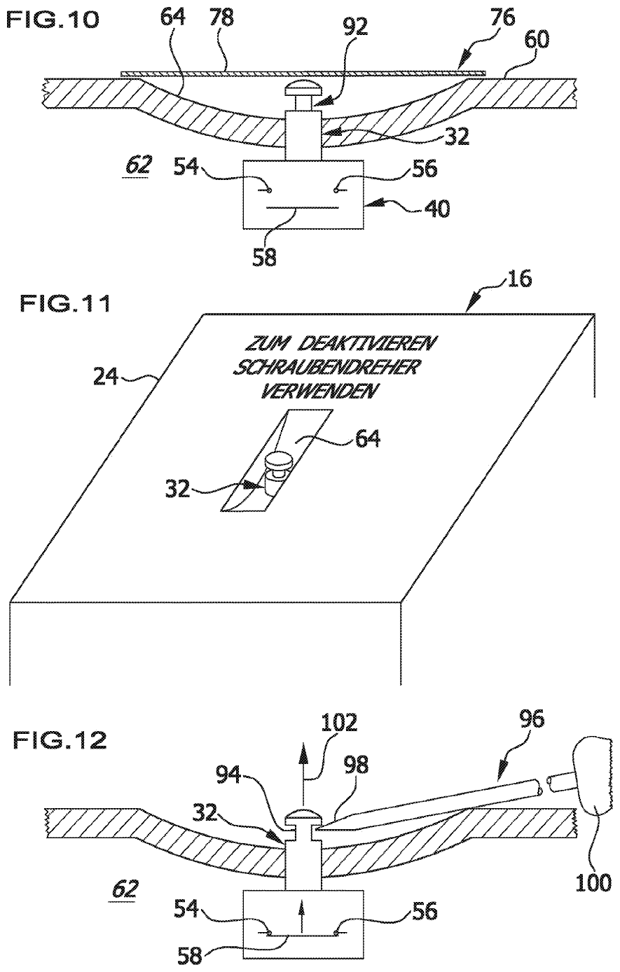

FIG. 10 shows a schematic partial sectional view of a further embodiment of an electrical energy storage device;

FIG. 11 shows a perspective view of the energy storage device partially illustrated in FIG. 10;

FIG. 12 shows a schematic illustration of the arrangement according to FIG. 10 during activation of the deep-discharge device;

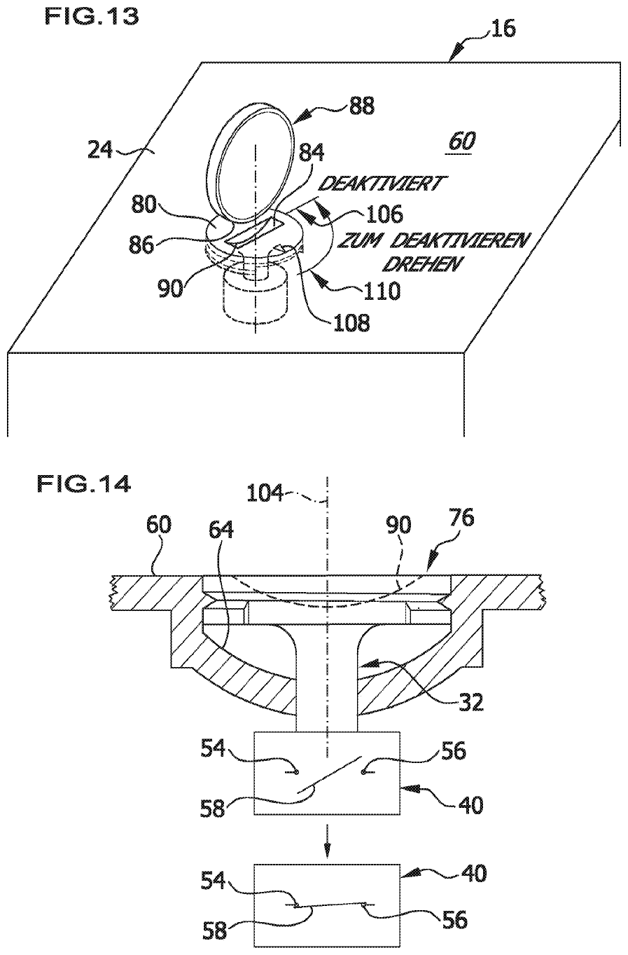

FIG. 13 shows a schematic perspective partial view of a further embodiment of an electrical energy storage device;

FIG. 14 shows a schematic partial sectional view of the arrangement according to FIG. 13;

FIG. 15 shows a schematic perspective partial view of a further embodiment of an electrical energy storage device;

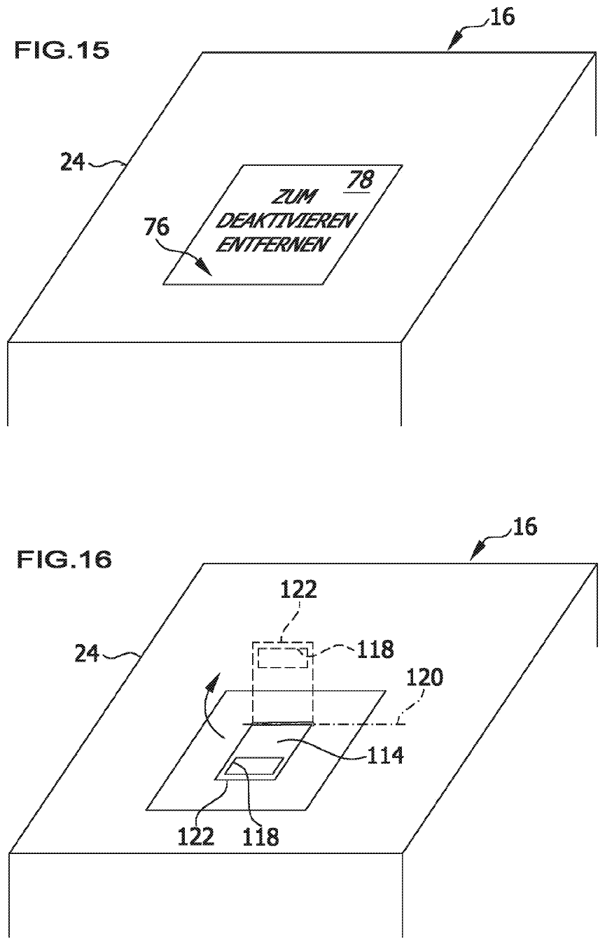

FIG. 16 shows a schematic view of the arrangement according to FIG. 15 during activation of the deep-discharge device;

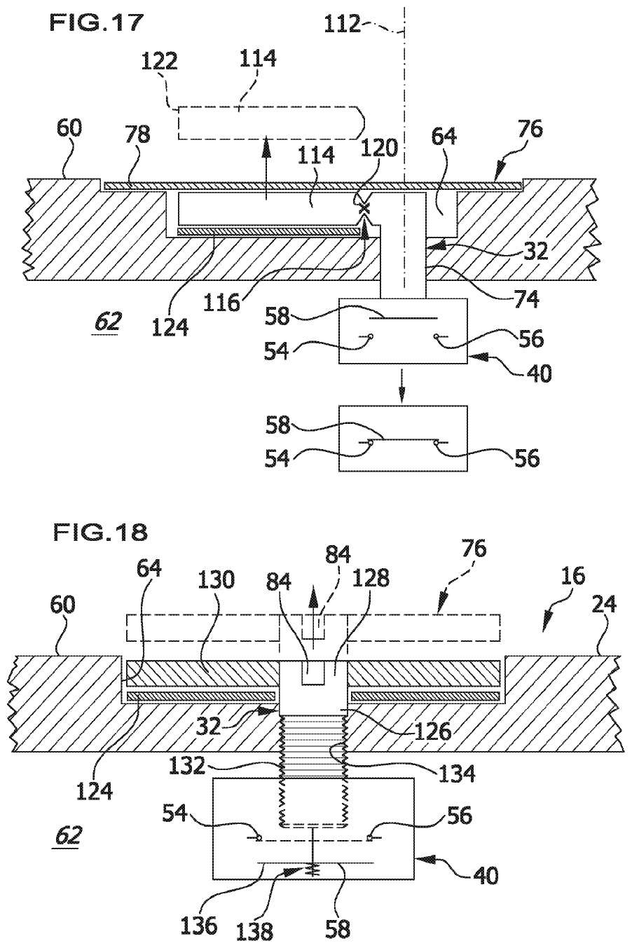

FIG. 17 shows a schematic partial sectional view of the arrangement according to FIG. 16; and

FIG. 18 shows a schematic partial sectional view of a further embodiment of an electrical energy storage device.

FIG. 1 schematically illustrates an embodiment of a battery-electrically operated electrical appliance 10. It comprises at least one electrical load 12.

Depending on the embodiment, the electrical appliance 10 is configured in the form of a cleaning device 14, a power tool, or a garden tool. However, other types of battery-electrically operated electrical appliances 10 are likewise conceivable.

An electrical energy storage device 16 serves to supply the at least one electrical load 12 of the electrical appliance 10 with electrical energy. Two embodiments of electrical energy storage devices 16 are schematically illustrated in FIG. 1.

In the embodiment illustrated in FIG. 1, the at least one electrical load 12 is configured in the form of a heating device and/or in the form of an electric motor 18.

The electrical energy storage device 16 is configured to be detachably connectable to the battery-electrically operated electrical appliance 10 such that, in an operating position, it is in electrical operative connection with the electrical appliance 10 and, in a storage position, as schematically illustrated in FIG. 1, is disengaged from the electrical appliance 10. For detachable connection, first and second connecting elements 20 and 22 are provided, which are arranged or formed on the electrical appliance 10 and on the energy storage device 16, respectively. In the operating position, the connecting elements 20 and 22 are engaged with one another, whereas in the storage position they are disengaged from one another. In the operating position, the first and second connecting elements 20 and 22 provide both a mechanical and an electrical operative connection between the electrical appliance 10 and the electrical energy storage device 16. Accordingly, in the operating position of the electrical load 12 the electrical appliance 10 can be supplied with electrical energy by the electrical energy storage device 16.

The electrical energy storage device 16 comprises a housing 24 in which at least one rechargeable battery cell 26 is accommodated. In FIG. 1, the two illustrated embodiments of electrical energy storage devices 16 are equipped either with a plurality of battery cells 26 or with only a single battery cell 26.

A control and/or regulation unit 28, likewise accommodated within the housing 24, serves to control and/or regulate charging and discharging of the at least one rechargeable battery cell 26 and to monitor a state of charge thereof. The control and/or regulation unit 28 is commonly referred to also as a Battery Management System (BMS). The electrical energy storage device 16 may additionally be referred to as a so-called battery pack.

The energy storage devices 16 further comprise an electrical deep-discharge device 30 for irreversibly deep-discharging the at least one battery cell 26. The electrical deep-discharge device 30 is configured independently of the control and/or regulation unit 28 and can likewise be actuated or activated independently thereof.

FIG. 2 illustrates a further embodiment of an electrical energy storage device 16. In this embodiment as well as in all further embodiments described in more detail below, identical reference numerals are used for identical or functionally similar components.

FIG. 2 schematically illustrates a mechanically actuable actuating element 32. It is comprised by the deep-discharge device 30. Likewise, FIG. 1 schematically illustrates such an actuating element 32 for each of the two embodiments of electrical energy storage devices 16. The actuating element 32 serves for actuating or activating, respectively, the deep-discharge device 30, as will be explained in greater detail below.

In FIG. 2, the actuating element 32 is configured as a movable element of the housing 24, namely in the form of a hard-plastic switch or button that can be depressed. In a manner not described in greater detail, it serves to close a circuit for deep-discharging the at least one battery cell 26, as will be explained below.

FIG. 3 shows a schematic illustration of the structure of an embodiment of an electrical energy storage device 16.

The deep-discharge device 30 comprises a deep-discharge circuit 34, which electrically conductively connects a first terminal 36 and a second terminal 38 of the battery cell 26. The deep-discharge circuit 34 comprises an electrical deep-discharge switching element 40.

In an operating position of the electrical energy storage device 16, the deep-discharge switching element 40 interrupts the deep-discharge circuit 34. Accordingly, the deep-discharge circuit 34 is open in the operating position. Consequently, no current can flow from one of the terminals 36, 38 to the other via the deep-discharge circuit 34.

By contrast, in a closed deep-discharge position, the deep-discharge circuit 34 is closed.

In this deep-discharge position, current can flow from one of the terminals 36, 38 to the other.

The deep-discharge switching element 40 can be transferred from the operating position into the deep-discharge position, but not vice versa. Accordingly, the deep-discharge switching element 40 is irreversibly actuable.

In the described embodiment, the deep-discharge switching element 40 is configured to be actuated exclusively mechanically. It comprises a pushbutton that is self-latching in the deep-discharge position, a plug connection, or, as schematically illustrated in FIG. 3, a switch 42,. The deep-discharge switching element 40 is configured in the form of an electrically passive component. Accordingly, it cannot be controlled electrically or electronically.

In order to limit current flow within the deep-discharge circuit 34, the deep-discharge circuit 34 comprises at least one electrical deep-discharge resistor 44. The latter forms an electrical load 46 which converts the electrical energy stored in the battery cell 26 into heat in the deep-discharge position.

The deep-discharge resistor has a resistance value in a range from approximately 2 ohms to 20 kΩ.

A heat-conducting element 48, optionally comprised by the electrical energy storage device 16, serves to dissipate the heat generated at the deep-discharge resistor 44, or at the electrical load 46, in the deep-discharge position. The deep-discharge circuit 34, and in particular the electrical load 46, is thermally conductively connected to the heat-conducting element 48. The heat-conducting element 48 is preferably arranged or configured such that via it not only heat from the deep-discharge circuit 34 during deep discharge of the battery cell 26 can be dissipated, but that the heat can also be conducted out of the housing 24. For this purpose, the heat-conducting element 48 is in contact with an outer surface 50 of the housing 24 or forms part thereof. Alternatively, the electrical load 46 itself may be arranged in a manner similar to the heat-conducting element 48 schematically illustrated in FIG. 3, in order to transfer or dissipate the heat generated in the deep-discharge position directly to the surroundings 52 of the electrical energy storage device 16.

In FIG. 3, the deep-discharge switching element 40 is schematically illustrated, namely as comprising first and second contact elements 54 and 56 which are electrically operatively connected to the first terminal 36 on the one hand and electrically operatively connected to the second terminal 38 on the other hand. As schematically illustrated in FIG. 3, the contact elements 54 and 56 are separated from one another in the operating position. A schematically illustrated movable contact tongue 58 is connected only to the second contact element 56 and does not contact the first contact element 54. Accordingly, the deep-discharge circuit 34 is interrupted. It assumes the operating position.

In the deep-discharge position, the contact tongue 58 contacts the first contact element 54 in a manner not illustrated in FIG. 3, such that the deep-discharge circuit 34 is closed and the first and second terminals 36, 38 are electrically operatively connected via the deep-discharge circuit 34. As a result, current can flow through the electrical load 46, thereby converting the energy contained in the battery cell 26 at the electrical load 46 completely into heat.

The actuating element 32 is configured to be movable from an unactuated initial position, in which the deep-discharge switching element 40 assumes the operating position and the deep-discharge circuit 34 is thus interrupted, by application of an actuating force into the deep-discharge position, in which the deep-discharge switching element 40 assumes the closed deep-discharge position and, consequently, the deep-discharge circuit 34 is closed.

FIG. 4 schematically illustrates a further embodiment of an electrical energy storage device 16. This comprises two battery cells 26 whose terminals 36 and 38 are each interconnected via a respective deep-discharge circuit 34. The two deep-discharge circuits 34 are configured in the same manner as described with reference to FIG. 3, and reference may therefore be made to the foregoing description. Optionally, a heat-conducting element 48 is assigned to each electrical load 46 if the heat generated at the electrical load 46 in the deep-discharge position cannot be dissipated directly from the housing 24 to the surroundings 52.

In the embodiment according to FIG. 4, only one single actuating element 32 is provided. This is operatively connected to both deep-discharge switching elements 40 of the two deep-discharge circuits 34. By actuating the actuating element 32, for example by applying an actuating force thereto, both deep-discharge switching elements 40 can be transferred from the operating position into the deep-discharge position, in particular simultaneously, whereby, as explained above, the deep-discharge circuits 34 are closed, such that both battery cells 26 can be deep-discharged by conversion of the electrical energy stored therein into heat within the electrical loads 46. The actuating element 32 may be configured in different ways. An embodiment in this regard is illustrated in FIGS. 5 to 7.

In this embodiment, the actuating element 32 is arranged or configured on the housing 24 so as to be recessed relative to an outer housing surface 60 in the direction of a housing interior 62 defined by the housing 24. For this purpose, the housing 24 comprises a housing recess 64 formed or arranged relative to the outer housing surface 60. The actuating element 32 is arranged or configured in or in the region of the housing recess 64.

The actuating element 32 is configured in the form of a button 66 and displaceable on the housing 24 along an actuation axis 68. The actuating element 32 is in direct mechanical operative connection with the deep-discharge switching element 40. In this embodiment, the actuating element 32 is arranged or configured such that it is displaceable relative to the housing 24 in order to transfer the deep-discharge switching element 40 from the operating position into the deep-discharge position. In particular, the actuating element 32 is operatively connected to the first or second contact element 54 or 56, for example via the contact tongue 58. If the button 66 is actuated, for example by a finger, and thus moved toward the housing interior 62, in particular by application of an actuating force symbolized by arrow 70, the contact tongue 58 is transferred from an open position, schematically illustrated in FIG. 6, into a closed position, schematically illustrated in FIG. 7, in which position, the two contact elements 54 and 56 are electrically conductively connected to one another. The deep-discharge circuit 34 is therefore closed in the position illustrated in FIG. 7.

The deep-discharge switching element 40 is preferably configured such that, after release by the user's finger 72, the button 66 does not automatically return to the original position illustrated in FIG. 6, but instead remains in the position illustrated in FIG. 7, in which the deep-discharge circuit 34 remains closed.

In the embodiment shown in FIGS. 5 to 7, the deep-discharge switching element 40 may alternatively comprise the actuating element 32. For example, the button 66 may be as an actuating pin 74 both in mechanical and electrical operative connection with the electrical deep-discharge switching element 40 such that the electrical deep-discharge switching element 40 can be transferred from the operating position into the deep-discharge position.

In particular, the actuating element 32 may be formed integrally, especially monolithically, with the first or second contact element 54, 56 or be connected to the first or second contact element 54, 56, in particular to the contact tongue 58, by force-fitting, form-fitting, and/or material-bonding engagement.

FIGS. 6 and 7 further schematically illustrate alternative embodiments of deep-discharge switching elements 40, which are enclosed by dashed circles. In these embodiments, the contact tongue 58 is not in contact with either of the two contact elements 54, 56 when in the operating position (see FIG. 6). As already explained, the contact tongue 58 may be mechanically coupled to the actuating pin 74 so as to be transferred from the operating position, schematically shown on the right-hand side of FIG. 6, into the deep-discharge position schematically shown on the right-hand side of FIG. 7, in which position the contact tongue 58, which forms a conductive region of the actuating pin 74 and thus of the actuating element 32, is in contact with both contact elements 54, 56 and closes the deep-discharge circuit 34.

In FIG. 6, a protective element 76 is schematically illustrated, which closes the housing recess 64 in a protective position. Accordingly, the actuating element 32 is concealed, covered, and protected by the protective element 76 in the operating position illustrated in FIG. 6. The protective element 76 closes the housing recess 64, which is open in a direction facing away from the housing interior 62.

In this embodiment, the protective element 76 and the housing 24 are configured to be irreversibly separable from one another on. The protective element 76 is configured in the form of a protective film 78 adhesively attached to the housing 24.

As can be seen clearly in FIG. 6, the protective element 76 is arranged in the protective position, in which it closes the housing recess 64, such that the mechanically actuable actuating element 32 is concealed and access thereto is impossible.

In order to actuate the actuating element 32, the protective element 76 must first be removed at least partially. Only thereafter can the actuating element 32 be actuated by application of an actuating force, as described above.

The removal of the protective element 76 indicates to a user that the deep-discharge device 30 may already have been actuated. The actuating element 32 itself forms an indicating element for actuation of the deep-discharge device 30. Based on its position—either projecting from the housing 24 as illustrated in FIG. 6 or substantially fully recessed into the housing 24 as illustrated in FIG. 7—a user can immediately recognize whether the deep-discharge device 30 has already been actuated.

A further embodiment of an electrical energy storage device 16 is schematically illustrated in FIGS. 8 and 9. It differs from the embodiment according to FIGS. 5 to 7 only with respect to the configuration of the protective element 76.

In the embodiment according to FIGS. 8 and 9, the protective element 76 is configured in the form of a cover 80 which is connected to the housing 24 by force-fitting, form-fitting, and/or material-bonding engagement in the protective position, in which the protective element 76 closes the housing recess 64 and covers and protects the actuating element 32. In the protective position, the cover 80 is connected to, or screwed to, the housing 24 by means of a screw connection 82.

A tool-coupling element 84 is formed on the protective element 76 for engagement with a correspondingly configured tool element 86 of a tool 88. The tool-coupling element 84 is configured in the form of a slot 90. A tool element 86 forming edge of a coin forming a tool 88 can engage in the slot 90. By means of this coin, the cover 80 can be unscrewed from the housing 24. The actuating element 32 is then freely accessible and can be actuated as described above in connection with FIGS. 5 to 7.

FIGS. 10 to 12 illustrate a further embodiment of an electrical energy storage device 16. In terms of structure and function, it is similar to the energy storage device 16 illustrated in FIGS. 5 to 7.

In the embodiment according to FIGS. 10 to 12, the actuating element 32 is likewise movably arranged or configured in the region of a housing recess 64. The housing recess 64 is closed in a protective position by a protective element 76 in the form of a protective film 78, as schematically illustrated in FIG. 10.

Unlike the embodiment according to FIGS. 5 to 7, the actuating element 32 comprises an actuation-tool element 92 in the form of a circumferential annular groove 94. In the operating position, in which the deep-discharge circuit 34 is open, the actuating element 32 is arranged such that the actuation-tool element 92 is freely accessible.

Unlike the embodiment according to FIGS. 5 to 7, the actuating element 32 in the embodiment according to FIGS. 10 to 12 is not moved toward the housing interior 62 in order to transfer the deep-discharge device from the operating position into the deep-discharge position, but rather away therefrom. For this purpose, for example, a tool 96 in the form of a screwdriver may be used. A tip 98 of the screwdriver 96 is brought into engagement with the annular groove 94, and the actuating element 32 is moved away from the housing interior 62 by pivoting a handle 100 of the screwdriver toward the housing 24. In this manner, the actuating element 32 is partially levered out of the housing 24.

In this embodiment as well, the deep-discharge switching element 40 is configured such that the actuating element 32 is connected or coupled to, for example, a contact tongue 58. In the operating position schematically illustrated in FIG. 10, the contact tongue 58, which forms an electrically conductive element, is out of engagement with both contact elements 54 and 56. If the actuating element 32 is moved away from the housing 24 in the direction of arrow 102, as schematically illustrated in FIG. 12, the contact tongue 58 comes into contact with the contact elements 54 and 56, thereby closing the deep-discharge circuit 34.

FIGS. 13 and 14 illustrate a further embodiment of an electrical energy storage device 16. In terms of structure, it is similar to the embodiment according to FIGS. 8 and 10.

The housing recess 64 is closed by a protective element 76 in the form of a cover 80. This is not removable from the housing 24 but is rotatable relative thereto about an axis of rotation 104 extending transversely, in particular perpendicularly, to a housing surface 60 of the housing 24.

On an outer side, the cover 80 comprises a tool-coupling element 84 in the form of a slot 90. This can again be actuated by a tool 88 comprising a tool element 86, namely by rotating it about the axis of rotation 104. A coin whose edge functions as the tool element 86 may again be used as the tool 88.

In this embodiment, the actuating element 32 is arranged or configured so as to be rotatable on the housing 24. The actuating element 32 is operatively connected to an electrically conductive element, for example the contact tongue 58. As a result of rotation of the actuating element 32, the contact tongue 58 can likewise be rotated therewith.

In the operating position, the contact tongue 58 is positioned, as schematically illustrated in FIG. 14, such that it contacts neither the first contact element 54 nor the second contact element 56. As a result of rotation of the protective element 76, which is rotationally fixedly connected or coupled to the actuating element 32 or is integrally formed therewith, the contact tongue 58 can be transferred into the deep-discharge position, as schematically illustrated in FIG. 14, in which it simultaneously contacts the first and second contact elements 54 and 56 and thereby closes the deep-discharge circuit 34.

Whether the actuating element 32 and thus the deep-discharge device 30 are in the operating position or in the deep-discharge position can be determined in particular from corresponding markings provided on the electrical energy storage device 16. A first marking 106 formed on the housing 24 indicates a position toward which a second marking 108 on the protective element 76 must point in order to indicate to a user that the deep-discharge device 30 is in the deep-discharge position. In the operating position, as schematically illustrated in FIG. 13, the second marking 108 does not point toward the first marking 106. In this embodiment, rotation in the direction of arrow 110 about the axis of rotation 104 by approximately 90° is required in order to transfer the deep-discharge switching element 40 from the operating position into the deep-discharge position.

FIGS. 15 to 17 illustrate a further embodiment of an electrical energy storage device 16. In terms of structure, it is similar to the embodiment according to FIGS. 5 to 7.

In the embodiment according to FIGS. 15 to 17, a housing recess 64 is likewise provided in which an actuating element 32 in the form of an actuating pin 74 is displaceable along a longitudinal axis 112 defined by the pin toward the housing interior 62 of the housing 24. As described in connection with the embodiment according to FIGS. 5 to 7, the actuating element 32 is operatively connected to an electrically conductive element, for example the contact tongue 58, in order to transfer the deep-discharge switching element 40 from the operating position, in which the deep-discharge circuit 34 is open, into the deep-discharge position, in which the deep-discharge circuit 34 is closed.

For actuating the actuating element 32 at a free end thereof a lever member 114 projecting transversely to the longitudinal axis 112 is provided. The lever member is irreversibly detachable from the actuating element 32 via a predetermined breaking point 116.

The lever member 114 comprises an opening 118 forming an engagement region into which a user can insert a finger and pivot the lever member 114 about a pivot axis 120 defined by the predetermined breaking point 116 such that a free end 122 of the lever member 114 is pivoted toward the longitudinal axis 112.

As a result of such pivoting movement of the lever member 114 about the pivot axis 120, the actuating element 32 is moved toward the housing interior 62, whereby the electrically conductive element, for example the contact tongue 58, can come into contact with both contact elements 54 and 56 of the deep-discharge switching element 40 and thereby close the deep-discharge circuit 34.

If the lever member 114 is pivoted sufficiently far toward the longitudinal axis 112, the predetermined breaking point 116 is irreversibly destroyed and the lever member 114 is separated from the actuating element 32, as schematically illustrated in dashed lines in FIG. 17.

The actuating element 32 can then no longer be moved further. The deep-discharge device 30 remains in the deep-discharge position.

By removal of the lever member 114, an indicating element 124, for example color-coded, becomes visible to a user. The indicating element 124, which may in particular be colored green or red, is arranged within the housing recess 64 and is concealed by the lever member 114 in the operating position. Accordingly, if the indicating element 124 is visible to a user, this serves as an indication that the deep-discharge device 30 has already been actuated.

In order to protect the actuating element 32 against unintentional actuation, the embodiment according to FIGS. 15 to 17 likewise provides a protective element 76 in the form of a protective film 78, which covers the housing recess 64 and thus also the actuating element 32. Consequently, in order to gain access to the lever member 114 for deep-discharging the electrical energy storage device 16, a user must first remove the protective element 76.

A further embodiment of an electrical energy storage device 16 is schematically illustrated in FIG. 18. In this embodiment, an actuating element 32 in the form of a screw 126 is provided. The screw 126 comprises a flange 130 projecting radially from a head 128 and closing or substantially closing the housing recess 64 in the operating position in the manner of a protective element 76.

The screw 126 further comprises an external thread 132 which, in the operating position, engages an internal thread 134 of the housing 24.

A tool-coupling element 84 facing away from the housing 24 is formed on the head 128 and can be brought into engagement with a tool element 86 of a tool 88. The tool-coupling element 84 is configured either in the form of a slot, an internal multi-lobbed profile, an internal polygon, or a cross-shaped recess. This enables a user to unscrew the screw 126 from the housing 24 by means of a corresponding screwdriver.

A free end 136 of the screw 126, facing toward the housing interior 62, is operatively connected to an electrically conductive element, for example a type of contact tongue 58, such that the end 136 keeps the contact tongue 58 spaced apart from the contact elements 54 and 56 in the operating position. When the screw 126 is unscrewed from the housing 24, the contact tongue 58 moves toward the contact elements 54 and 56, for example under the action of a spring element 138 of the deep-discharge switching element 40. Once the screw 126 has been removed, the spring element 138 irreversibly presses the contact tongue 58 against the contact elements 54 and 56.

Within the housing recess 64, an indicating element 124 is arranged or formed, similarly to the embodiment according to FIGS. 15 to 17, which becomes visible after removal of the screw 126 and thus of the protective element 76. For example, the indicating elements 124 in the embodiments according to FIGS. 15 to 18 may be colored green, thereby signalling to a user, when visible, that the deep-discharge device 30 is in the deep-discharge position.

The embodiments of electrical energy storage devices described above make it possible, in particular, at the end of the life cycle of the electrical energy storage devices 16, to remove residual electrical energy remaining in the at least one battery cell 26 therefrom, namely by converting the residual energy into heat in the electrical load 46 of the deep-discharge circuit 34. Depending on the configuration of the electrical energy storage device 16, the generated heat can be dissipated from the housing 24, for example by means of a heat-conducting element 48, optionally including an additional heat sink, in order to prevent overheating of the electrical energy storage device 16 and thereby prevent possible ignition or explosion thereof.

In all described embodiments, the deep-discharge device 30 is configured such that it can be actuated independently of the control and/or regulation unit 28. For this purpose, a mechanical actuating element 32 is provided. Upon actuation thereof, the deep-discharge circuit 34 is closed such that the residual energy stored in the battery cell 26 can be discharged via the electrical load 46 and converted into heat.

The described embodiments of electrical energy storage devices 16 further ex-hibit the property that it is immediately recognizable to a user, i.e. be indicated, whether the deep-discharge device 30 is in the operating position or in the deep-discharge position. Accordingly, at the end of the life cycle of the electrical energy storage device 16, a user can deliberately deep-discharge the battery cell 26, which would normally be prevented by the control and/or regulation unit 28. In the manner described, electrical energy storage devices 16 can be safely and reliably disposed of at the end of their life cycle.

### REFERENCE NUMERALS LIST

10 Electrical appliance
12 Electrical load
14 Cleaning device
16 Electrical energy storage device
18 Electric motor
20 First connecting element
22 Second connecting element
24 Housing
26 Battery cell
28 Control and/or regulation unit
30 Deep-discharge device
32 Actuating element
34 Deep-discharge circuit
36 First terminal
38 Second terminal
40 Deep-discharge switching element
42 Switch
44 Deep-discharge resistor
46 Electrical load
48 Heat-conducting element
50 Outer surface
52 Surroundings
54 First contact element
56 Second contact element
58 Contact tongue
60 Housing surface
62 Housing interior
64 Housing recess
66 Button
68 Actuation axis
70 Arrow
72 Finger
74 Actuating pin
76 Protective element
78 Protective film
80 Cover
82 Threaded connection
84 Tool-coupling element
86 Tool element
88 Tool
90 Slot
92 Actuation-tool element
94 Annular groove
96 Tool
98 Tip
100 Handle
102 Arrow
104 Axis of rotation
106 First marking
108 Second marking
110 Arrow
112 Longitudinal axis
114 Lever member
116 Predetermined breaking point
118 Opening
120 Pivot axis
122 Free end
124 Indicating element
126 Screw
128 Head
130 Flange
132 External thread
134 Internal thread
136 End
138 Spring element

1. An electrical energy storage device, comprising a housing, at least one rechargeable battery cell accommodated within the housing, and a control and/or regulation unit for controlling and/or regulating charging and discharging of the at least one rechargeable battery cell and for monitoring a state of charge thereof, characterized in that the electrical energy storage device comprises an electrical deep-discharge device for irreversibly deep-discharging the at least one battery cell, and in that the electrical deep-discharge device is configured independently of the control and/or regulation unit and can be actuated or activated independently thereof.

2. The electrical energy storage device according to claim 1, wherein the deep-discharge device comprises at least one deep-discharge circuit electrically conductively connecting a first terminal and a second terminal of the at least one battery cell, and in that the deep-discharge circuit comprises at least one electrical deep-discharge switching element, which is open in an operating position in which the at least one deep-discharge circuit is interrupted and which can be irreversibly transferred from the open operating position into a closed deep-discharge position in which the at least one deep-discharge circuit is closed, wherein, in particular, the at least one deep-discharge switching element is configured to be actuated exclusively mechanically.

3. The electrical energy storage device according to claim 2, wherein the deep-discharge switching element
a) is configured in the form of a pushbutton self-latching in the deep-discharge position, a switch, or a plug connection,
and/or
b) is configured in the form of an electrically passive component.

4. The electrical energy storage device according to claim 2, wherein the deep-discharge switching element comprises a first contact element operatively electrically connected to the first terminal and a second contact element operatively electrically connected to the second terminal, the first and second contact elements being separated from one another in the operating position and being in electrically conductive operative connection with one another in the deep-discharge position.

5. The electrical energy storage device according to claim 2, wherein the deep-discharge device comprises at least one, in particular only one single, mechanically actuable actuating element, which is movable from an unactuated initial position, in which the deep-discharge switching element assumes the operating position, into a deep-discharge position by application of an actuating force, in which the deep-discharge switching element assumes the closed deep-discharge position, wherein, in particular, the deep-discharge switching element comprises the actuating element.

6. The electrical energy storage device according to claim 5, wherein
the actuating element is
a) movably arranged on the housing,
and/or
b) movable from the operating position into the deep-discharge position toward or away from a housing interior defined by the housing,
and/or
c) arranged or configured so as to be displaceable and/or pivotable and/or rotatable.

7. The electrical energy storage device according to claim 5, wherein the actuating element is arranged or configured such that, for transferring the deep-discharge switching element from the operating position into the deep-discharge position, the actuating element is displaceable and/or rotatable and/or pivotable relative to the housing.

8. The electrical energy storage device according to claim 5, wherein the actuating element comprises an actuating pin which is in mechanical and electrical operative connection with the electrical deep-discharge switching element such that the electrical deep-discharge switching element can be transferred from the operating position into the deep-discharge position.

9. The electrical energy storage device according to claim 5, wherein the actuating element is operatively connected to the first contact element for moving the first contact element from the operating position into the deep-discharge position.

10. The electrical energy storage device according to claim 5, wherein the actuating element is formed integrally, in particular monolithically, with the first contact element, or is connected to the first contact element by force-fitting, form-fitting, and/or material-bonding engagement.

11. The electrical energy storage device according to claim 5, wherein the actuating element comprises or forms the first contact element.

12. The electrical energy storage device according to claim 5, wherein the actuating element is in electrically operative connection with the first and second contact elements in the deep-discharge position and is in electrically operative connection with neither or only one of the two contact elements in the operating position.

13. The electrical energy storage device according to claim 5, wherein the actuating element
a) comprises an actuation-tool element for force-fitting and/or form-fitting engagement with an actuation tool for moving the actuating element,
and/or
b) is arranged or configured on the housing in a recessed manner relative to an outer housing surface in the direction of a housing interior defined by the housing.

14. The electrical energy storage device according to claim 5, wherein the actuating element is arranged or configured in or in the region of a housing recess arranged or formed relative to the outer housing surface, wherein, in particular, the housing recess is open in a direction facing away from the housing interior.

15. The electrical energy storage device according to claim 5, wherein the electrical deep-discharge device comprises two or more deep-discharge circuits
a) wherein each deep-discharge circuit comprises an actuating element or an actuating element is assigned to each deep-discharge circuit,
or
b) comprises only a single actuating element, which is in mechanical operative connection with all deep-discharge switching elements of the deep-discharge device for transferring all deep-discharge switching elements, in particular simultaneously or successively, from the operating position into the deep-discharge position.

16. The electrical energy storage device according to claim 5, wherein in the operating position the actuating element is concealed, covered, and/or protected by a protective element.

17. The electrical energy storage device according to claim 16, wherein the protective element
a) closes the housing recess in the operating position,
and/or
b) is configured in the form of a cover,
and/or
c) is connected to the housing in a protective position by force-fitting, form-fitting, and/or material-bonding engagement,
wherein, in particular, the protective element and the housing are configured to be irreversibly separable from one another.

18. The electrical energy storage device according to claim 16, wherein the protective element
a) is configured in the form of a protective film adhesively attached to the housing,
and/or
b) is connected to or engaged with the housing in a protective position via a bayonet connection or threaded connection,
and/or
c) is arranged in a protective position such that the mechanically actuable actuating element is concealed and access thereto is impossible,
and/or
d) comprises a tool-coupling element for engagement with a correspondingly configured tool element of a tool,
wherein, in particular, the tool-coupling element (84) is configured in the form of a slot.

19. The electrical energy storage device according to claim 2, wherein the at least one deep-discharge circuit comprises at least one electrical deep-discharge resistor, which converts the electrical energy stored in the at least one battery cell into heat in the deep-discharge position, wherein, in particular, the at least one deep-discharge resistor has a resistance value in a range from approximately 2 ohms to approximately 20 kΩ.

20. The electrical energy storage device according to claim 2, wherein the electrical energy storage device comprises at least one heat-conducting element, and in that the at least one deep-discharge circuit is thermally conductively connected to the at least one heat-conducting element in order to dissipate heat generated in the at least one deep-discharge circuit therefrom during deep discharge, in particular out of the housing,
wherein, in particular, the at least one heat-conducting element comprises at least one heat sink that is thermally conductively connected to the at least one deep-discharge circuit, in particular to the at least one electrical deep-discharge resistor.

21. The electrical energy storage device according to claim 1, wherein the at least one battery cell is configured in the form of a lithiumion battery.

22. The electrical energy storage device according to claim 2, wherein the electrical energy storage device comprises two or more rechargeable battery cells, and in that the deep-discharge device comprises a single deep-discharge circuit for all battery cells, a deep-discharge circuit for two or more battery cells, or a separate deep-discharge circuit for each battery cell.

23. A battery-electrically operated electrical appliance comprising at least one electrical load and an electrical energy storage device for supplying the at least one electrical load with electrical energy, characterized in that the electrical energy storage device is configured in the form of an electrical energy storage device,
wherein, in particular,
a) the electrical appliance is configured in the form of a cleaning device, a power tool, an electrically driven vehicle, in particular a motor vehicle, or a garden tool,
and/or
b) the at least one electrical load is configured in the form of a heating device and/or in the form of an electric motor,
and/or
c) the electrical energy storage device is configured to be detachably connectable to the battery-electrically operated electrical appliance such that, in an operating position, it is in electrical operative connection with the electrical appliance and, in a storage position, is disengaged from the electrical appliance.

24. A method for electrically deep-discharging an electrical energy storage device comprising at least one rechargeable battery cell and a control and/or regulation unit for controlling and/or regulating charging and discharging of the at least one rechargeable battery cell and for monitoring a state of charge thereof, characterized in that the at least one battery cell is irreversibly deep-discharged independently of the control and/or regulation unit.

25. The method according to claim 24, wherein for deep-discharging the at least one rechargeable battery cell, a first terminal and a second terminal of the battery cell are transferred from an operating position, in which they are electrically conductively disengaged from one another, into a deep-discharge position in which they are electrically conductively connected directly or indirectly via at least one electrical load, such that the electrical energy stored in the at least one battery cell is converted into heat in the deep-discharge position, in particular by means of the at least one electrical load.

26. (canceled)
